(19) United States
(12) Patent Application Publication
(10) Pub. No.: US 2026/0361197 A1
(43) Pub. Date: Nov. 12, 2026

(54) VIBRATION GENERATING DEVICE

(71) Applicant: ALPS ALPINE CO., LTD., Tokyo (JP)

(72) Inventors: Takaaki KAMEYAMA, Miyagi (JP); Hideki ITO, Miyagi (JP); Kazuhiko AMANO, Miyagi (JP); Yusuke KAZASHI, Miyagi (JP)

(21) Appl. No.: 19/733,079

(22) Filed: Jul. 7, 2026

Related U.S. Application Data
(63) Continuation of application No. PCT/JP2024/042046, filed on Nov. 27, 2024.

(30) Foreign Application Priority Data
Jan. 12, 2024 (JP) 2024-003503

(51) Int. Cl. H02K 33/18

(52) U.S. Cl. CPC H02K 33/18

(57) ABSTRACT

A vibration generating device includes housings and a vibration unit, in which the vibration unit includes: an elastic support configured to support one of a coil or a magnet such that the one of the coil or the magnet can vibrate in a first direction; and a retainer configured as a metal plate configured to retain the other of the coil or the magnet, one of the housings includes a positioning portion provided at a predetermined height from a bottom plate of the one of the housings, the other of the housings includes a leg configured as a plate, the retainer includes a mounting plate, the leg includes a pair of claws, the mounting plate fits between the claws, and inner edges of the claws are inclined such that a distance between the claws gradually increases toward the distal direction of the leg.

### CROSS-REFERENCE TO RELATED APPLICATIONS

This application is a continuation application of International Application No. PCT/JP2024/042046, filed on Nov. 27, 2024, and designated the U.S., which is based upon and claims priority to Japanese Patent Application No. 2024-003503, filed on Jan. 12, 2024, the entire contents of which are incorporated herein by reference.

### BACKGROUND OF THE INVENTION

### 1. Field of the Invention

The present invention relates to a vibration generating device.

### 2. Description of the Related Art

Electronic devices of the related art, such as portable information terminals (e.g., smartphones, mobile phones, and tablet terminals), game consoles, and information display devices mounted on vehicles such as automobiles, employ vibration generating devices capable of generating vibration to provide users with tactile notifications of various incoming communications (e.g., incoming calls, incoming emails, and incoming social networking service (SNS) messages) and tactile feedback to user operations.

Regarding such vibration generating devices, for example, Japanese Patent Application Laid-Open Publication No. 2023-009796 discloses a technique for positioning a first plate in a height direction relative to a housing by clamping a protruding plate of the first plate from above and below using a first curved portion provided on a side plate of a first housing and a second curved portion provided on a side plate of a second housing.

However, in the technique disclosed in Japanese Patent Application Laid-Open Publication No. 2023-009796, although the first plate can be positioned in the Y direction by fitting the protruding plate of the first plate into a first cutout recess provided in the side plate of the first housing, play of the first plate may occur in the Y direction relative to the housing if the dimension of the first cutout recess in the Y direction becomes larger than the dimension of the protruding plate in the Y direction due to manufacturing variations or the like.

### SUMMARY OF THE INVENTION

A vibration generating device according to one embodiment includes: a metal housing including a lower housing and an upper housing; and a vibration unit provided inside the metal housing and having a magnet and a coil that are arranged to face each other in an up-down direction, the vibration unit configured to generate vibration in a first direction orthogonal to the up-down direction, in which the vibration unit includes: an elastic support configured to support one of the coil or the magnet such that the one of the coil or the magnet can vibrate in the first direction; and a retainer configured as a metal plate configured to retain the other of the coil or the magnet, one of the upper housing or the lower housing includes a positioning portion provided at a predetermined height from a bottom plate of the one of the upper housing or the lower housing, the other of the upper housing or the lower housing includes a leg configured as a plate, the retainer includes a mounting plate protruding from an outer edge of the retainer and clamped between the positioning portion and the leg, the leg includes a pair of claws spaced apart from each other in a horizontal direction orthogonal to the up-down direction and protruding in a distal direction of the leg, the mounting plate fits between the claws, and inner edges of the claws are inclined such that a distance between the claws gradually increases toward the distal direction of the leg.

### BRIEF DESCRIPTION OF THE DRAWINGS

FIG. 1 is an external perspective view of a vibration generating device according to one embodiment;

FIG. 2 is an exploded perspective view of the vibration generating device according to one embodiment;

FIG. 3 is an external perspective view of a vibration unit according to one embodiment;

FIG. 4 is a side view of the vibration unit according to one embodiment;

FIG. 5 is an exploded perspective view of the vibration unit according to one embodiment;

FIG. 6 is an enlarged exploded view of retention structures included in the vibration generating device according to one embodiment;

FIG. 7 is an enlarged assembled cross-sectional view of the retention structures included in the vibration generating device according to one embodiment;

FIG. 8 is an explanatory diagram illustrating an assembling procedure for the retention structures included in the vibration generating device according to one embodiment;

FIG. 9 is an explanatory diagram illustrating the assembling procedure for the retention structures included in the vibration generating device according to one embodiment;

FIG. 10 is an explanatory diagram illustrating the assembling procedure for the retention structures included in the vibration generating device according to one embodiment;

FIG. 11 is an explanatory view of a main portion of each retention structure included in the vibration generating device according to one embodiment;

FIG. 12 is an explanatory view of the main portion of each retention structure included in the vibration generating device according to one embodiment; and

FIG. 13 is a diagram illustrating a main portion of a retention structure included in a vibration generating device according to another embodiment.

### DESCRIPTION OF THE EMBODIMENTS

Hereinafter, one embodiment will be described with reference to the drawings. In the following description, for convenience, the Z-axis direction, the X-axis direction, and the Y-axis direction in the drawings are defined as an up-down direction, a front-back direction, and a left-right direction, respectively.

### Configuration of Vibration Generating Device 100

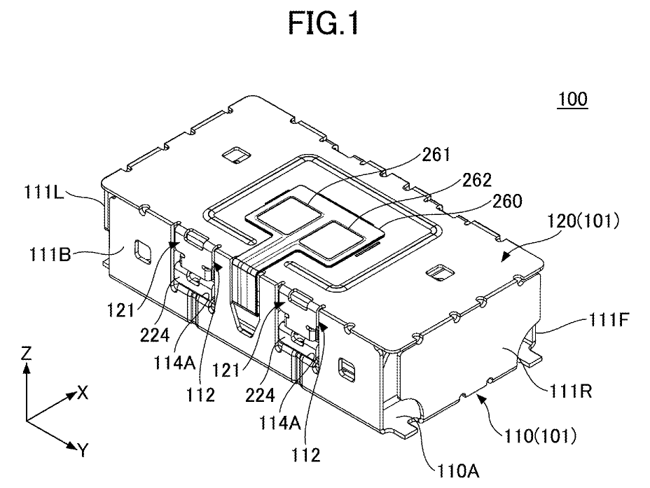

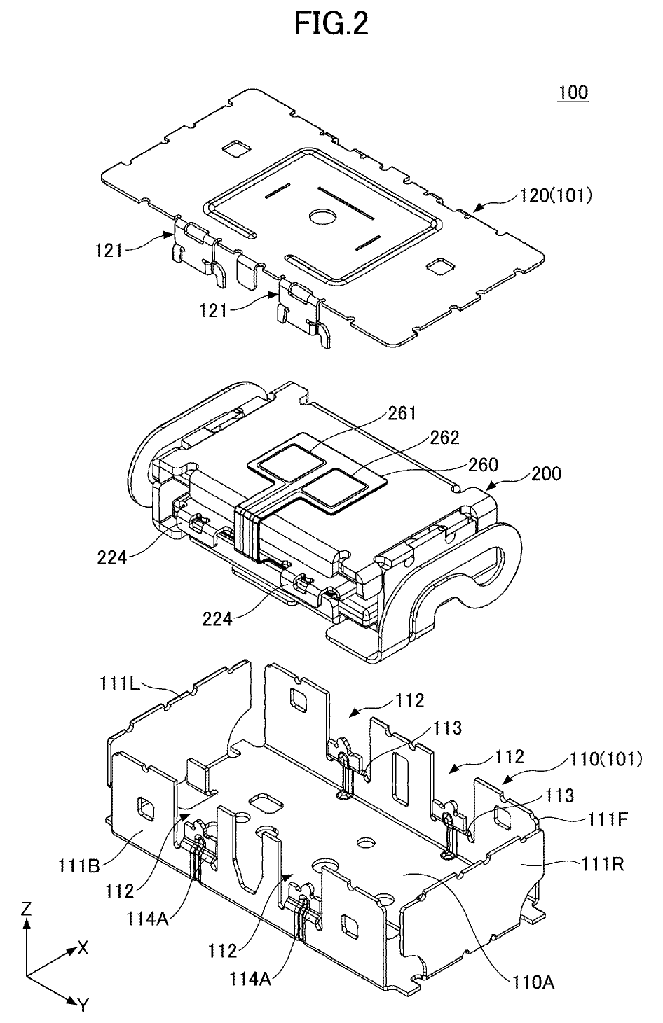

FIG. 1 is an external perspective view of a vibration generating device 100 according to one embodiment. FIG. 2 is an exploded perspective view of the vibration generating device 100 according to one embodiment.

The vibration generating device 100 illustrated in FIGS. 1 and 2 is a device mounted on, for example, electronic devices, such as portable information terminals (e.g., smartphones, mobile phones, and tablet terminals), game consoles, and information display devices mounted on vehicles such as automobiles. The vibration generating device 100 is used, for example, to generate vibration to provide a user with tactile notifications of various incoming communications (e.g., incoming calls, incoming emails, and incoming SNS messages) and tactile feedback to user operations.

As illustrated in FIGS. 1 and 2, the vibration generating device 100 includes a housing 101 and a vibration unit 200 provided inside the housing 101.

The housing 101 is a box formed by processing sheet metal. The housing 101 has a substantially rectangular parallelepiped shape with a low profile in the up-down direction (Z-axis direction). The housing 101 includes a lower housing 110 and an upper housing 120 that are separable from each other.

The lower housing 110 is a container that has a substantially rectangular parallelepiped shape and has an open top. The lower housing 110 includes a flat bottom plate 110A having a substantially rectangular shape in a top view. The lower housing 110 includes a left sidewall 111L on a negative Y-axis side, a right sidewall 111R on a positive Y-axis side, a front sidewall 111F on a positive X-axis side, and a back sidewall 111B on a negative X-axis side. The left sidewall 111L, the right sidewall 111R, the front sidewall 111F, and the back sidewall 111B extend upward from an outer edge of the bottom plate 110A. The sidewall 111F and the sidewall 111B are each provided with two cutouts 112 arranged in the left-right direction (Y-axis direction). Each cutout 112 extends downward (in the negative Z-axis direction) from the upper edge of the sidewall 111F or the sidewall 111B and has a constant width in the left-right direction.

The upper housing 120 is a flat plate having a substantially rectangular shape in a top view. The upper housing 120 is attached to the lower housing 110 to close the upper opening. A front edge on a positive X-axis side and a back edge on a negative X-axis side of the upper housing 120 are each provided with two legs 121 arranged in the left-right direction (Y-axis direction). Each of the legs 121 is a plate extending downward from the corresponding edge of the upper housing 120. As illustrated in FIG. 1, the legs 121 are inserted from above into the corresponding cutouts 112 of the lower housing 110 so that the upper housing 120 closes the upper opening of the lower housing 110, and the upper housing 120 is fixed to the lower housing 110 in this state.

The vibration unit 200 is provided inside the housing 101 and configured to generate vibration in the left-right direction (Y-axis direction; an example of a "first direction" and a “horizontal direction”).

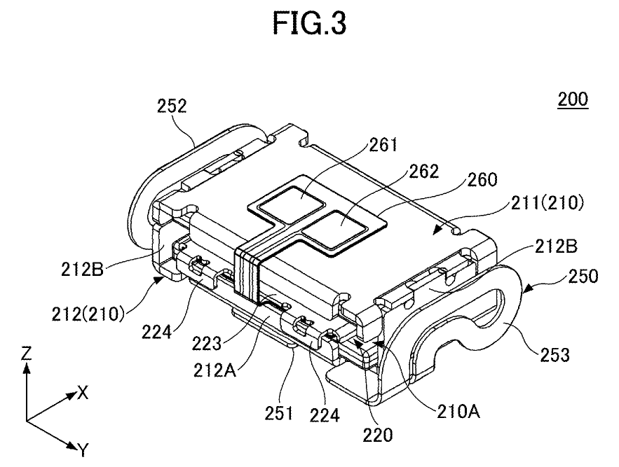

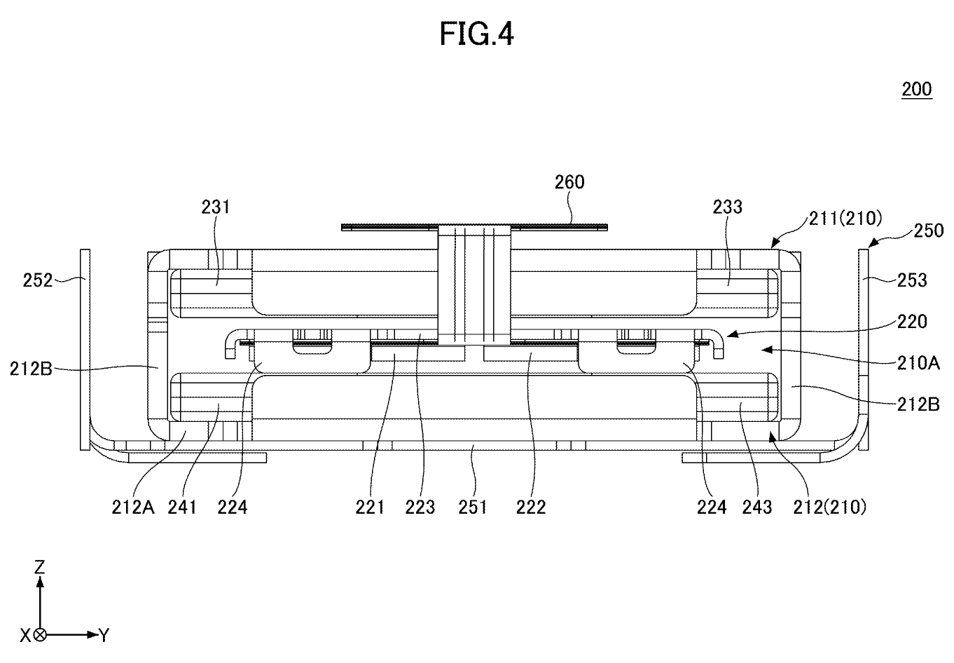

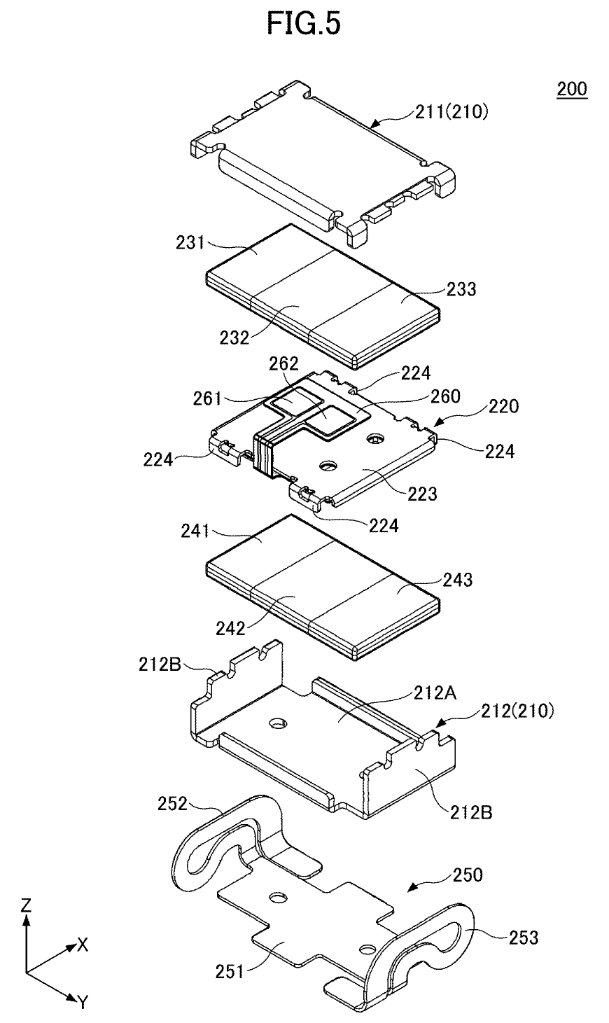

Configuration of Vibration Unit 200
FIG. 3 is an external perspective view of the vibration unit 200 according to one embodiment. FIG. 4 is a side view of the vibration unit 200 according to one embodiment. FIG. 5 is an exploded perspective view of the vibration unit 200 according to one embodiment.

As illustrated in FIGS. 3 to 5, the vibration unit 200 includes a yoke 210, three magnets 231, 232, and 233, a coil assembly 220, three magnets 241, 242, and 243, an elastic support 250, and a flexible printed circuit (FPC) 260.

The yoke 210 is formed of a magnetic material (e.g., pure iron or low-carbon steel) and includes a flat upper yoke 211 and a container lower yoke 212. The yoke 210 is a substantially rectangular parallelepiped box with an internal space 210A by combining the upper yoke 211 and the lower yoke 212 with each other. The yoke 210 retaining the magnets 231, 232, 233, 241, 242, and 243 vibrates in the left-right direction (Y-axis direction) by a reaction to an electromagnetic force generated by the coil assembly 220 fixed to the housing 101. The yoke 210 is an example of a “retainer.”

The upper yoke 211 retains the three magnets 231, 232, and 233 on a lower surface of the upper yoke 211. The upper yoke 211 concentrates magnetic flux from the three magnets 231, 232, and 233 to increase a magnetic force acting on two coils 221 and 222.

The lower yoke 212 retains the three magnets 241, 242, and 243 on an upper surface of a bottom plate 212A of the lower yoke 212, which will be described later. The lower yoke 212 concentrates magnetic flux from the three magnets 241, 242, and 243 to increase a magnetic force acting on the two coils 221 and 222.

The lower yoke 212 includes the bottom plate 212A and a pair of walls 212B. The bottom plate 212A is a horizontal flat plate having a substantially rectangular shape in a top view. The bottom plate 212A retains the three magnets 241, 242, and 243. The walls 212B are provided at left and right ends of the bottom plate 212A. The walls 212B extend vertically from the corresponding ends of the bottom plate 212A.

Left and right ends of the upper yoke 211 are attached to corresponding upper ends of the two walls 212B so that the lower yoke 212 supports the upper yoke 211 at a predetermined height. Accordingly, the internal space 210A is formed between the bottom plate 212A of the lower yoke 212 and the upper yoke 211. The three magnets 231, 232, and 233, the coil assembly 220, and the three magnets 241, 242, and 243 can be disposed in the internal space 210A.

The three magnets 231, 232, and 233 are fixed to the lower surface of the upper yoke 211. The three magnets 231, 232, and 233 are provided above the coil assembly 220 (in the positive Z-axis direction), spaced apart from the coil assembly 220 by a predetermined distance, and arranged in the left-right direction (Y-axis direction). Each of the three magnets 231, 232, and 233 is a flat permanent magnet having a rectangular shape of which the longitudinal sides extend in the front-back direction (X-axis direction) when viewed from above (in the positive Z-axis direction).

Each of the three magnets 231, 232, and 233 has an upper half magnetized to either an N-pole or an S-pole, and a lower half magnetized to the other of the N-pole and the S-pole. Note that, for adjacent two magnets of the three magnets 231, 232, and 233, the upper half and the lower half of one magnet are magnetized to different poles from those of the other magnet. Instead of the three magnets 231, 232, and 233, a single magnet forming equivalent poles may be used.

The three magnets 241, 242, and 243 are fixed to the upper surface of the lower yoke 212. The three magnets 241, 242, and 243 are provided below the coil assembly 220 (in the negative Z-axis direction), spaced apart from the coil assembly 220 by a predetermined distance, and arranged in the left-right direction (Y-axis direction). Each of the three magnets 241, 242, and 243 is a flat permanent magnet having a rectangular shape of which the longitudinal sides extend in the front-back direction (X-axis direction) when viewed from above (in the positive Z-axis direction).

Each of the three magnets 241, 242, and 243 has an upper half magnetized to either an N-pole or an S-pole, and a lower half magnetized to the opposite pole. Note that, for adjacent two magnets of the three magnets 241, 242, and 243, the upper half and the lower half of one magnet are magnetized to different poles from those of the other magnet.

The upper half of each of the three magnets 241, 242, and 243 faces the lower half of each of the three magnets 231, 232, and 233, respectively, and is magnetized to a different pole from that of the facing lower half.

For example, when the lower halves of the three magnets 231, 232, and 233 are magnetized to an N-pole, an S-pole, and an N-pole, respectively, the upper halves of the three magnets 241, 242, and 243 are magnetized to an S-pole, an N-pole, and an S-pole, respectively.

In the vibration unit 200 according to one embodiment, the three magnets 231, 232, and 233 are used, but a single magnet forming equivalent magnetic poles may be used instead. Similarly, instead of the three magnets 241, 242, and 243, a single magnet forming equivalent magnetic poles may be used.

The coil assembly 220 is disposed between the three magnets 231, 232, and 233 and the three magnets 241, 242, and 243 inside the yoke 210. The coil assembly 220 generates an electromagnetic force by being driven with an alternating drive current having a predetermined frequency, and vibrates the yoke 210 in the left-right direction (Y-axis direction) by a reaction to the electromagnetic force.

As illustrated in FIG. 4, the coil assembly 220 includes the two coils 221 and 222, and a coil holder 223.

The two coils 221 and 222 are arranged in the left-right direction (Y-axis direction). Each of the two coils 221 and 222 has an oval annular shape of which the major axis extends in the front-back direction (X-axis direction) when viewed from above (in the positive Z-axis direction), and is formed by multiple turns of an electric wire (e.g., a copper wire coated with an insulator) so as to form the oval annular shape. Further, each of the two coils 221 and 222 is formed to be relatively thin in the up-down direction (Z-axis direction).

Note that the coil 221 is provided below the magnets 231 and 232 and above the magnets 241 and 242 and extends over the magnets 231 and 232 and the magnets 241 and 242 in a top view. The coil 222 is provided below the magnets 232 and 233 and above the magnets 242 and 243 and extends over the magnets 232 and 233 and the magnets 242 and 243 in a top view.

The coil holder 223 is a horizontal flat plate formed by processing sheet metal and having a substantially rectangular shape when viewed from above. The coil holder 223 retains the two coils 221 and 222 on a lower surface of the coil holder 223.

The coil holder 223 has two mounting plates 224 arranged in the left-right direction (the Y-axis direction) at each of a front outer edge (positive X-axis side) and a back outer edge (negative X-axis side). Each mounting plate 224 is a plate portion projecting from the corresponding outer edge of the coil holder 223. The total of four mounting plates 224 are provided at positions corresponding to the four cutouts 112 of the lower housing 110. Each mounting plate 224 has a constant width smaller than a width of each cutout 112 in the left-right direction (Y-axis direction), extends a predetermined distance from the corresponding outer edge of the coil holder 223 in the front-back direction (X-axis direction), is bent downward (in the negative Z-axis direction) at a right angle, and extends a predetermined distance downward (in the negative Z-axis direction).

Each mounting plate 224 is disposed within the corresponding cutout 112 formed in the front sidewall 111F or the back sidewall 111B of the lower housing 110, and is placed on a stage 114C (positioning portion) provided within each cutout 112 to be positioned at a predetermined height. Thereafter, each leg 121 of the upper housing 120 is inserted into the corresponding cutout 112, so that each mounting plate 224 is clamped between the corresponding stage 114C and a lower end of each leg 121. Accordingly, the coil holder 223 is retained at a predetermined height relative to the lower housing 110 by the lower housing 110 and the upper housing 120. The retention structure of the coil holder 223 (retainer) will be described later in more detail.

The elastic support 250 is formed by processing sheet metal, is interposed between the housing 101 and the yoke 210, and supports the yoke 210 such that the yoke 210 can vibrate in the left-right direction (Y-axis direction) relative to the housing 101. Specifically, the elastic support 250 has a horizontal flat movable-body mounting plate 251, and the yoke 210 is mounted on an upper side of the movable-body mounting plate 251. Thus, the elastic support 250 supports the yoke 210 such that the yoke 210 can vibrate in the left-right direction (Y-axis direction) relative to the housing 101.

The elastic support 250 also has an elastic arm 252 and an elastic arm 253. The elastic arm 252 extends from a left end (negative Y-axis side end) of the movable-body mounting plate 251, and the elastic arm 253 extends from a right end (positive Y-axis side end) of the movable-body mounting plate. The elastic arm 252 and the elastic arm 253 function as leaf springs and are elastically deformable in the left-right direction (Y-axis direction). The elastic arm 252 and the elastic arm 253 have shapes point-symmetric to each other. Each of the elastic arms 252 and 253 has one end connected to the movable-body mounting plate 251 and the other end fixed to the bottom plate 110A of the lower housing 110. Thus, the elastic support 250 retains the yoke 210 such that the yoke 210 mounted on the movable-body mounting plate 251 can vibrate in the left-right direction (Y-axis direction) relative to the lower housing 110 because the elastic arm 252 and the elastic arm 253 elastically deform.

The FPC 260 is a component that connects the coils 221 and 222 to an external circuit (not illustrated) to supply an alternating current to the coils 221 and 222. The FPC 260 is a film having a structure in which interconnections formed of a metal film are interposed between resin materials such as polyimide. The FPC 260 has flexibility and thus is bendable. As illustrated in FIG. 1, the FPC 260 is disposed along the sidewall 111B of the lower housing 110 and the upper housing 120, and an end of the FPC 260 to the external circuit is positioned on an upper side of the upper housing 120. At the end of the FPC 260 to the external circuit, two electrode terminals 261 and 262 each made of a metal film are formed for electrically connecting the coils 221 and 222 to the external circuit.

Operation of Vibration Generating Device 100
In the vibration generating device 100 with the above configuration, when an alternating drive current is supplied from the external circuit (not illustrated) to the coils 221 and 222 via the FPC 260, the yoke 210 vibrates in the left-right direction (Y-axis direction), and the elastic arms 252 and 253 of the elastic support 250 elastically deform. The yoke 210 is retained on the movable-body mounting plate 251 of the elastic support 250 and retains the magnets 231, 232, 233, 241, 242, and 243.

Specifically, the two coils 221 and 222 are arranged in a magnetic field formed by the magnets 231, 232, 233, 241, 242, and 243 and the yoke 210. When a drive current in a first direction is passed through the two coils 221 and 222, a rightward force (electromagnetic force) in the positive Y-axis direction acts on the two coils 221 and 222 according to Fleming's left-hand rule.

Conversely, when a drive current in a second direction opposite to the first direction is passed through the two coils 221 and 222, a leftward force (electromagnetic force) in the negative Y-axis direction acts on the two coils 221 and 222 according to Fleming's left-hand rule.

Therefore, in the vibration generating device 100 according to one embodiment, by supplying an alternating drive current to the two coils 221 and 222, a rightward force (electromagnetic force) in the positive Y-axis direction and a leftward force (electromagnetic force) in the negative Y-axis direction alternately act on the two coils 221 and 222.

At this time, due to a relationship between action and reaction, forces in directions opposite to those acting on the two coils 221 and 222 alternately act on the three magnets 231, 232, and 233 and the three magnets 241, 242, and 243 retained by the yoke 210.

Therefore, by supplying the two coils 221 and 222 with an alternating drive current having the same frequency as a resonance frequency determined by a spring constant of the elastic arms 252 and 253 and a total mass of the yoke 210 and the magnets 231, 232, 233, 241, 242, and 243, the yoke 210 retaining the magnets 231, 232, 233, 241, 242, and 243 can be resonated and vibrated in the left-right direction (Y-axis direction).

In particular, since the two coils 221 and 222 are arranged in the left-right direction (Y-axis direction) in the yoke 210, the yoke 210 can be vibrated more greatly in the left-right direction (Y-axis direction) compared with a yoke provided with only one coil. However, the yoke 210 may be provided with one coil, or may be provided with three or more coils.

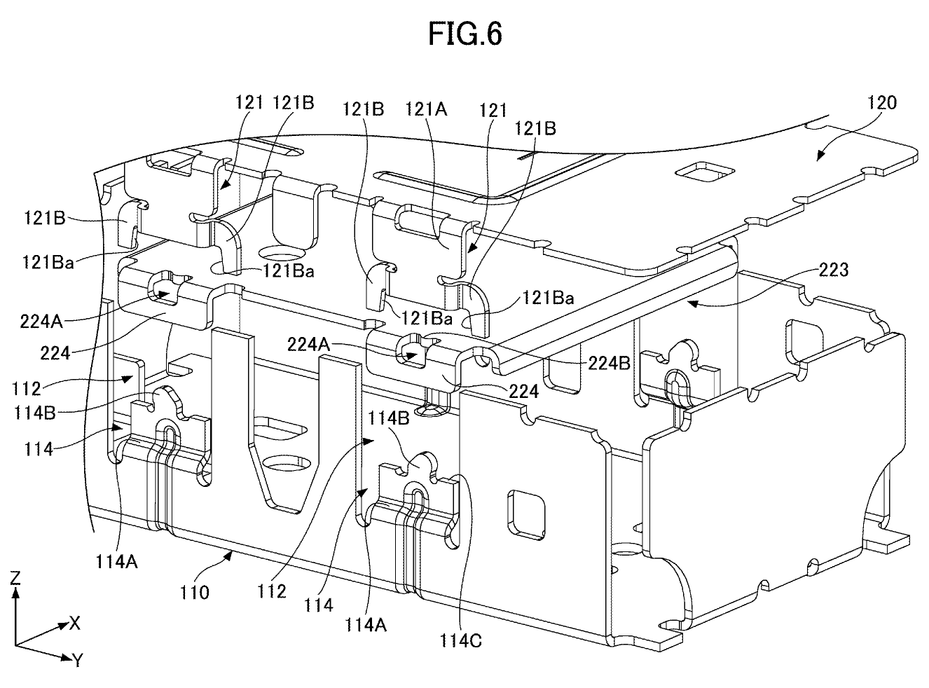

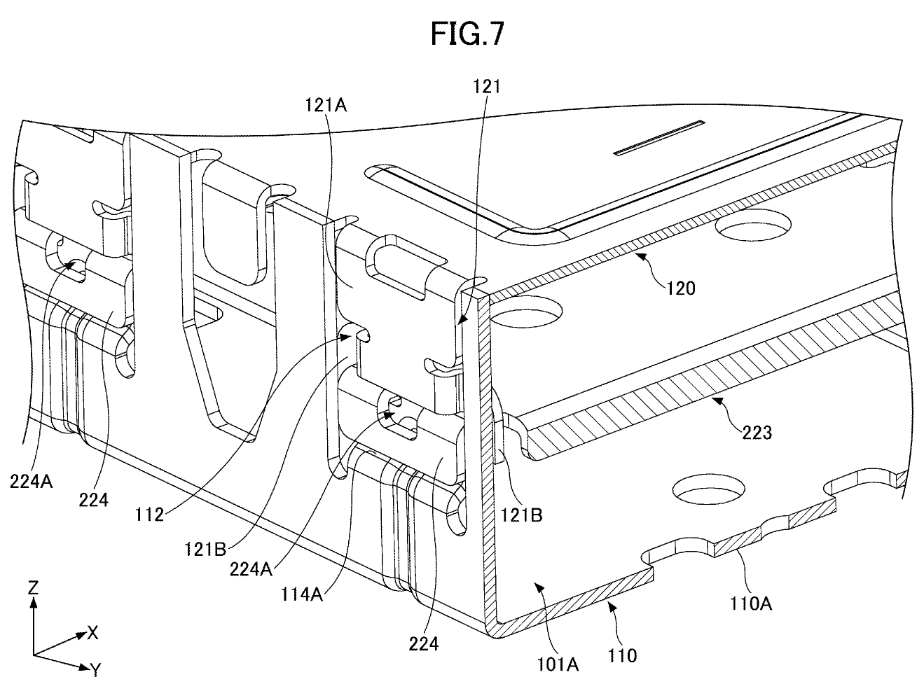

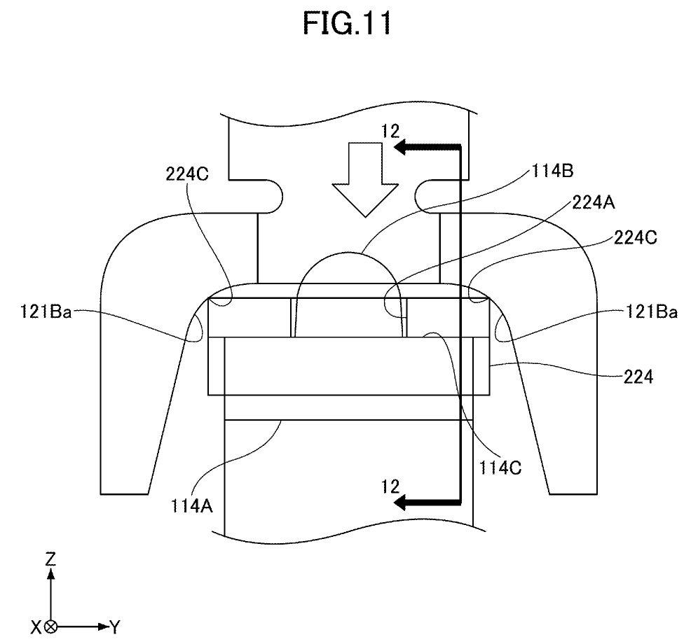

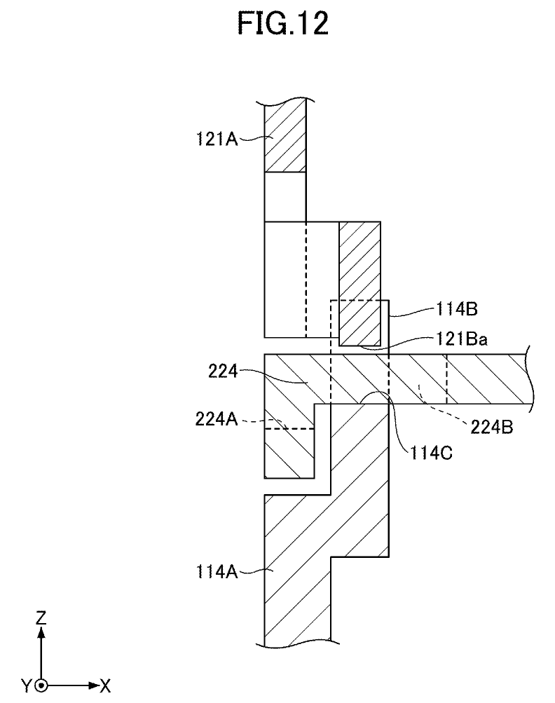

Retention Structure
FIG. 6 is an enlarged exploded view of the retention structures included in the vibration generating device 100 according to one embodiment. FIG. 7 is an enlarged assembled cross-sectional view of the retention structures included in the vibration generating device 100 according to one embodiment. FIGS. 11 and 12 are explanatory views of a main portion of each retention structure included in the vibration generating device 100 according to one embodiment. FIG. 11 is a see-through view illustrating a relationship among components from a back side (negative X-axis side). FIG. 12 corresponds to a cross section taken along line 12-12 in FIG. 11.

Note that FIGS. 6 and 7 illustrate the retention structures on the back side (negative X-axis side) of the vibration generating device 100, but the retention structures on the front side (positive X-axis side) of the vibration generating device 100 also have substantially the same configuration. FIGS. 11 and 12 illustrate the retention structure on the right back side (positive Y-axis side, negative X-axis side) of the vibration generating device 100, but the retention structure on the left back side (negative Y-axis side, negative X-axis side) also has substantially the same configuration.

As illustrated in FIGS. 6 and 7, each retention structure included in the vibration generating device 100 has an extension 114 provided in the corresponding cutout 112 of the lower housing 110, the corresponding leg 121 of the upper housing 120, and the corresponding mounting plate 224 of the coil holder 223.

Each cutout 112 is provided in the sidewall 111B of the lower housing 110 and extends downward (in the negative Z-axis direction) from the upper edge of the sidewall 111B while maintaining a constant width in the left-right direction.

Inside each cutout 112, the extension 114, which is a plate extending upward from a lower edge of the cutout 112, is provided. The extension 114 is bent toward the internal space 101A of the housing 101 at a lower end of the extension 114 and then is bent upward, thereby forming a step 114A. An upper end surface of the extension 114 serves as the stage 114C on which the mounting plate 224 is placed.

Since each extension 114 has the step 114A, the extension 114 is offset toward the internal space 101A of the housing 101 relative to the sidewall 111B. Thus, when the mounting plate 224 is placed on the stage 114C, the extension 114 is positioned inward of the bent portion at the proximal end of the mounting plate 224 that is substantially flush with the sidewall 111B, so as to overlap the mounting plate 224 within the internal space 101A.

Each extension 114 has a substantially hemispherical protrusion 114B extending upward from an upper end of the extension 114. The protrusion 114B is inserted into a through-hole 224A of the mounting plate 224 to limit play of the mounting plate 224 in the left-right direction relative to the lower housing 110 to a predetermined value or less while allowing the play.

Note that each mounting plate 224 is provided with a protrusion 224B extending into the through-hole 224A. When the protrusion 114B is inserted into the through-hole 224A of the mounting plate 224, the protrusion 224B comes into contact with a front surface (positive X-axis side), that is, an inner surface, of the protrusion 114B. Since the retention structures on the front side (positive X-axis side) of the vibration generating device 100 also has substantially the same configuration, a position of the coil holder 223 is thus determined in the front-back direction (X-axis direction) relative to the lower housing 110.

Each leg 121 of the upper housing 120 has a body 121A configured as a plate extending downward from an edge of the upper housing 120 with a constant width in the left-right direction. The body 121A is provided integrally with the upper housing 120, and extends downward by being bent at a right angle at a connection with the edge of the upper housing 120. A width of the body 121A in the left-right direction is smaller than the width of the cutout 112 in the left-right direction. Thus, the body 121A can be inserted into the cutout 112 from above.

Each leg 121 has a pair of claws 121B protruding downward and laterally from lower ends of the leg 121 in the left-right direction (Y-axis direction). By pushing the leg 121 downward from above while the mounting plate 224 is placed on the stage 114C, the mounting plate 224 of the coil holder 223 fits between the claws 121B. Thus, as illustrated in FIG. 11, the leg 121 can press upper corners 224C at the left and right ends of the mounting plate 224 from an obliquely upward direction by inner edges 121Ba of the claws 121B, thereby pressing the mounting plate 224 from above and from sides.

Specifically, the respective inner edges 121Ba of the claws 121B are inclined such that a distance between the claws 121B in the left-right direction gradually increases downward. The inner edges 121Ba that come into contact with the upper corners 224C at the left and right ends of the mounting plate 224 are tapered into an R-shape or the like such that a distance between the inner edges 121Ba in the left-right direction gradually increases downward. Accordingly, even when manufacturing variations occur in the width of the mounting plate 224 in the left-right direction, each leg 121 can press the upper corners 224C at the left and right ends of the corresponding mounting plate 224 from an obliquely upward direction by the inner edges 121Ba of the claws 121B at a height inside the claws 121B corresponding to the width of the mounting plate 224 in the left-right direction. Therefore, the coil holder 223 can be pressed against the stage 114C from above and simultaneously from left and right sides.

In each leg 121, the width of the body 121A in the left-right direction is smaller than the width of the corresponding cutout 112 in the left-right direction, and the width of a portion having the claws 121B is larger than the width of the cutout 112. Each of the claws 121B is bent toward the internal space 101A of the housing 101 at a right angle at a connection with the body 121A, and then bent again at a right angle to be parallel to the surface before being bent. Thus, the claws 121B are offset toward the internal space 101A of the housing 101 relative to the body 121A. Thus, when each leg 121 is inserted into the corresponding cutout 112 from above, the body 121A becomes substantially flush with the sidewall 111B. Inward of the sidewall 111B, the claws 121B are positioned to overlap the sidewall 111B in the front-back direction (X-axis direction) within the internal space 101A of the housing 101.

Further, as illustrated in FIG. 12, the inner edge 121Ba and the stage 114C face each other on the Z-axis to clamp the mounting plate 224 from above and below.

Each mounting plate 224 of the coil holder 223 is a plate protruding from an outer edge of the coil holder 223. The mounting plate 224 extends backward (in the negative X-axis direction) from the outer edge of the coil holder 223 by a predetermined distance and then is bent downward (in the negative Z-axis direction) at a right angle.

A width of each mounting plate 224 in the left-right direction is smaller than the width of the corresponding cutout 112 in the left-right direction. This allows the mounting plate 224 to be disposed inside the cutout 112. Inside the cutout 112, a lower surface of a portion of the mounting plate 224 extending backward (in the negative X-axis direction) by a predetermined distance is placed on the stage 114C. Thus, the coil holder 223 is positioned at a predetermined height.

A distal end of a portion that is bent downward (in the negative Z-axis direction) at a right angle is configured not to contact the step 114A of the lower housing 110. The distal end is bent downward at a position beyond the extension 114 from the inside of the housing 110. This configuration ensures that the mounting plate 224 extends from the inside of the housing 110 beyond the extension 114 to be placed on the stage 114C and/or guided by the protrusion 114B, while preventing an increase in dimension in the front-back direction (the X-axis direction).

The width of the mounting plate 224 in the left-right direction is greater than a minimum distance between the claws 121B of the corresponding leg 121 and less than a maximum distance between the claws 121B. With this configuration, when the leg 121 is inserted into the corresponding cutout 112 from above while the mounting plate 224 is placed on the stage 114C, the mounting plate 224 fits between the claws 121B of the leg 121. The respective inner edges 121Ba of the claws 121B press the left and right edges of the mounting plate 224 from above and from sides. This prevents play of the coil holder 223 in the up-down direction (the Z-axis direction) and the left-right direction (Y-axis direction) relative to the housing 101.

The through-hole 224A is formed at the center of an angular portion in the left-right direction (Y-axis-direction) formed by bending the mounting plate 224 at a right angle. The protrusion 114B of the extension 114 is inserted into the through-hole 224A. This limits play of the coil holder 223 in the left-right direction (Y-axis direction) relative to the lower housing 110 to a predetermined value or less while allowing the play.

In the vibration generating device 100 according to one embodiment, the retention structures described above are provided in pairs symmetrically on the sidewall 111F and the sidewall 111B of the housing 101. Thus, the vibration generating device 100 according to one embodiment can stably retain the coil holder 223 at a predetermined height without play.

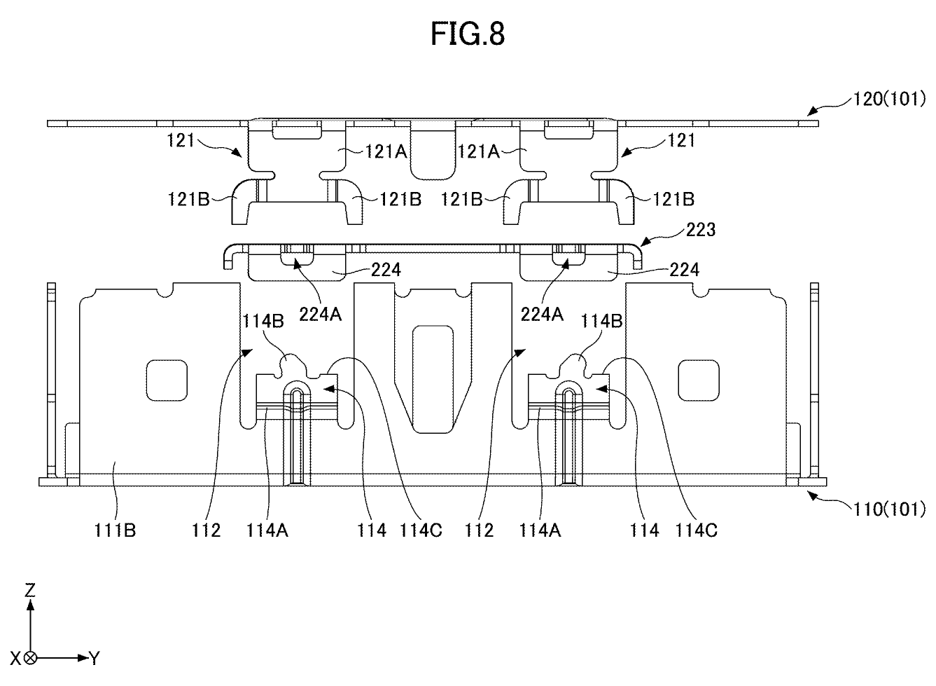

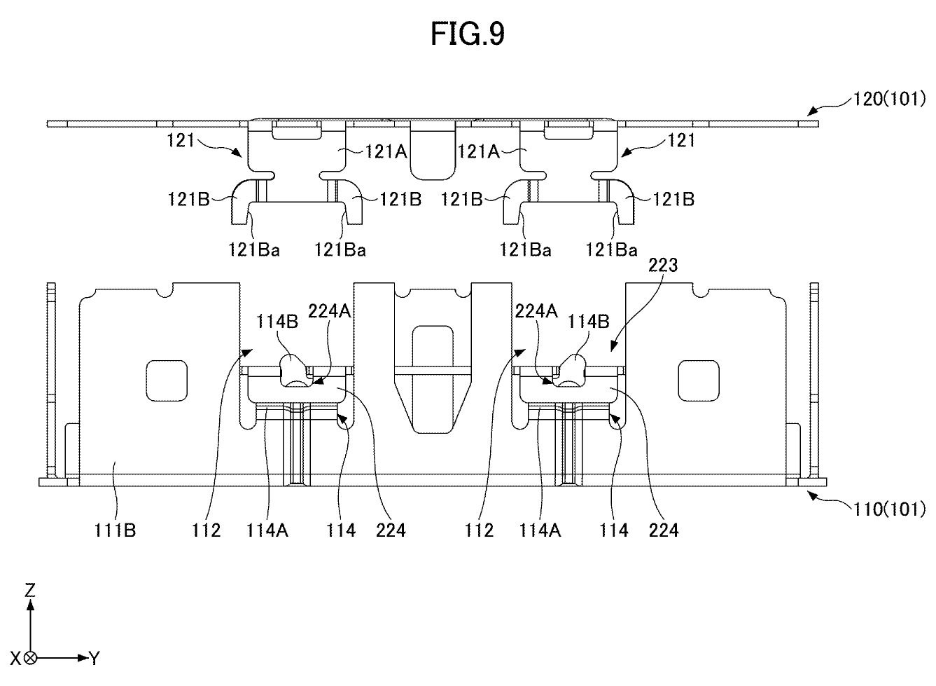

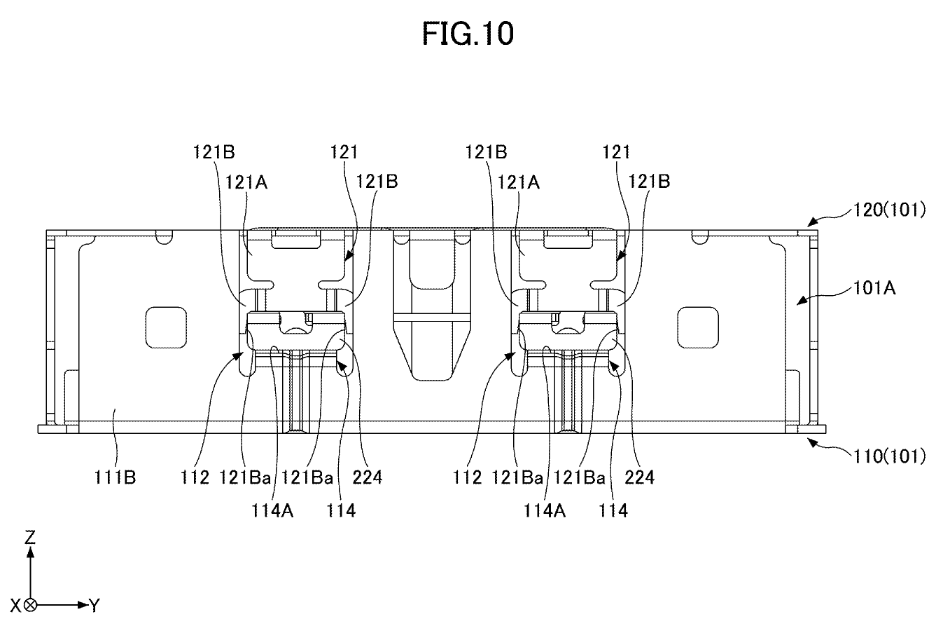

Assembling Procedure for Retention Structure
FIGS. 8 to 10 are explanatory diagrams illustrating an assembling procedure for the retention structures included in the vibration generating device 100 according to one embodiment. FIG. 8 illustrates the lower housing 110, the coil holder 223, and the upper housing 120 in an exploded state. FIG. 9 illustrates the coil holder 223 attached to the lower housing 110. FIG. 10 illustrates the upper housing 120 attached to the lower housing 110.

In this assembling procedure as illustrated in FIG. 9, the coil holder 223 is first disposed in a horizontal orientation inside the lower housing 110 from the upper opening of the lower housing 110.

At this time, the four mounting plates 224 of the coil holder 223 are inserted from above into the four corresponding cutouts 112 provided in the sidewall 111F and the sidewall 111B of the lower housing 110. Then, inside each of the four cutouts 112, the lower edge of the mounting plate 224 of the coil holder 223 is placed on the stage 114C included in the extension 114 of the lower housing 110. Accordingly, the coil holder 223 is placed on the lower housing 110 and positioned at a predetermined height as illustrated in FIG. 9.

Also at this time, as illustrated in FIG. 9, inside each of the four cutouts 112, the protrusion 114B included in the extension 114 of the lower housing 110 is inserted into the through-hole 224A of the mounting plate 224. This limits play of the coil holder 223 in the left-right direction (Y-axis direction) relative to the lower housing 110 to a predetermined value or less while allowing the play, when the coil holder 223 is placed on the lower housing 110.

In particular, in the present embodiment, the protrusion 114B on the left side (negative Y-axis side) illustrated in FIG. 9 is offset to the left side (negative Y-axis side) from the center of the through-hole 224A on the left side (negative Y-axis side) in the left-right direction (Y-axis direction). The protrusion 114B on the right side (positive Y-axis side) illustrated in FIG. 9 is offset to the right side (positive Y-axis side) from the center of the through-hole 224A on the right side (positive Y-axis side) in the left-right direction (Y-axis direction). With this configuration in the present embodiment, a left edge of the protrusion 114B on the left side (negative Y-axis side) is positioned in close proximity to an inner edge of the through-hole 224A on the left side (negative Y-axis side), thereby limiting movement of the coil holder 223 to the right (in the positive Y-axis direction) to a predetermined value or less, while a right edge of the protrusion 114B on the right side (the positive Y-axis side) is positioned in close proximity to an inner edge of the through-hole 224A on the right side (positive Y-axis side), thereby limiting movement of the coil holder 223 to the left (in the negative Y-axis direction) to a predetermined value or less.

Also at this time, inside each of the four cutouts 112, the protrusion 224B of the mounting plate 224 of the coil holder 223 is disposed in contact with the protrusion 114B of the extension 114 of the lower housing 110. Accordingly, movement of the coil holder 223 in the front-back direction (X-axis direction) relative to the lower housing 110 is restricted by the extension 114 while the coil holder 223 is attached to the lower housing 110.

Next, as illustrated in FIG. 10, the upper housing 120 is disposed in a horizontal orientation relative to the upper opening of the lower housing 110. At this time, the four legs 121 of the upper housing 120 are inserted from above into the four corresponding cutouts 112 provided in the sidewall 111F and the sidewall 111B of the lower housing 110. Accordingly, the upper housing 120 is disposed on the lower housing 110 as illustrated in FIG. 10.

As illustrated in FIG. 10, when the upper housing 120 is disposed on the lower housing 110, inside each of the four cutouts 112, the inner edges 121Ba of the claws 121B included in each leg 121 of the upper housing 120 press against the left and right ends of the corresponding mounting plate 224 of the coil holder 223 placed on the stage 114C of the lower housing 110 (i.e., upper corners 224C at the left and right ends of the mounting plate 224). Accordingly, each mounting plate 224 of the coil holder 223 is clamped between the stage 114C of the lower housing 110 and the leg 121 of the upper housing 120. As a result, the coil holder 223 is prevented from having play in the up-down direction (Z-axis direction) and the left-right direction (Y-axis direction) relative to the lower housing 110 and the upper housing 120.

At this time, the respective inner edges 121Ba of the claws 121B are inclined such that a distance between the claws 121B in the left-right direction gradually increases downward. Accordingly, even when manufacturing variations occur in the width of the mounting plate 224 in the left-right direction, the inner edges 121Ba of the claws 121B can press the upper corners 224C at the left and right ends of the corresponding mounting plate 224 from an obliquely upward direction at a height inside the claws 121B corresponding to the width of the mounting plate 224 in the left-right direction. This ensures that each mounting plate 224 can be pressed from above and from sides.

Also at this time, each pair of the claws 121B is arranged in the internal space 101A toward the corresponding sidewall 111F or 111B of the lower housing 110 to overlap the sidewall 111F or 111B. This restricts outward displacement (in the X-axis direction) of each leg 121 of the upper housing 120 by the sidewalls 111F and 111B of the lower housing 110 when each leg 121 is inserted into the corresponding cutout 112. Accordingly, impact resistance and the like of the vibration generating device 100 can be improved.

Thereafter, the periphery of the opening of the lower housing 110 and the periphery of the upper housing 120 are integrated by welding or the like.

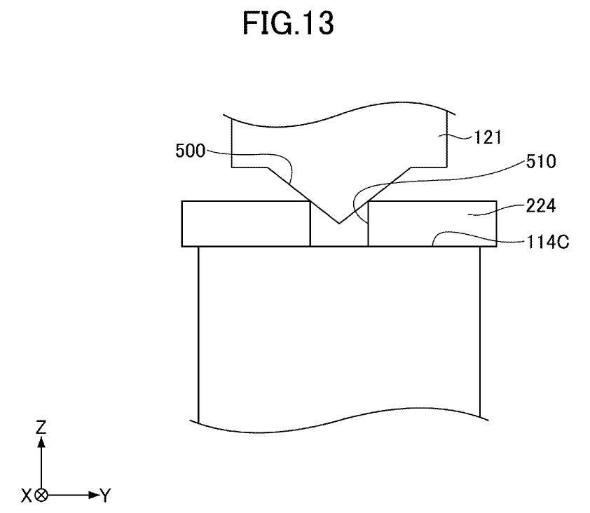

FIG. 13 is a diagram illustrating a main portion of a retention structure included in the vibration generating device 100 according to another embodiment. The components equivalent to those of each retention structure included in the vibration generating device 100 according to the one embodiment are denoted by the same reference numerals, and description thereof will be omitted or simplified as appropriate. In the example illustrated in FIG. 13, a leg 121 has a claw 500 protruding downward, and a through-hole 510 is provided in a mounting plate 224. The claw 500 fits into the through-hole 510, and the mounting plate 224 is clamped between the claw 500 and a stage 114C. The claw 500 is tapered so as to gradually narrow downward.

Other configurations are the same as those of the retention structures included in the vibration generating device 100 according to the one embodiment, and thus detailed description thereof will be omitted.

As described above, the vibration generating device 100 according to one embodiment includes: the metal housing 101 including the lower housing 110 and the upper housing 120; and the vibration unit 200 provided inside the housing 101 and having the magnets 231, 232, 233, 241, 242, and 243 and the coils 221 and 222 that are arranged to face each other in the up-down direction, the vibration unit 200 configured to generate vibration in the Y-axis direction (horizontal direction, first direction) orthogonal to the up-down direction, in which the vibration unit 200 includes: the elastic support 250 configured to support the magnets 231, 232, 233, 241, 242, and 243 such that the magnets 231, 232, 233, 241, 242, and 243 can vibrate in the first direction; and the coil holder 223 (retainer) configured as a metal plate configured to retain the coils 221 and 222, the lower housing 110 includes the stages 114C (positioning portions) provided at a predetermined height from the bottom plate 110A, the upper housing 120 includes the legs 121 each being a plate, the coil holder 223 includes the mounting plates 224 each protruding from the outer edge of the coil holder 223 and clamped between the corresponding stage 114C and the corresponding leg 121, each of the legs 121 has the pair of claws 121B spaced apart from each other in the Y-axis direction and protruding downward, each of the mounting plates 224 fits between the claws 121B of the corresponding pair, and the inner edges 121Ba of the claws 121B of each pair are inclined such that a distance between the claws 121B gradually increases downward.

Accordingly, in the vibration generating device 100 according to one embodiment, even when manufacturing variations occur in the width of the mounting plate 224, the inner edges 121Ba of the claws 121B can press the opposite ends of the corresponding mounting plate 224 from above and from sides at a height corresponding to the width of the mounting plate 224 received between the claws 121B. Thus, according to the vibration generating device of one embodiment, it is ensured that play of the coil holder 223, which is a metal plate configured to retain the coils 221 and 222, can be limited in the up-down direction and the horizontal direction. Moreover, a position of the coil holder 223 can be determined in the up-down direction by the stage 114C.

In the above embodiment, the stages 114C (positioning portions) are provided on the lower housing 110, and the legs 121 that are plates are provided on the upper housing 120. However, the legs 121 that are plates may be provided on the lower housing 110, and the positioning portions may be provided on the upper housing 120.

In the vibration generating device 100 according to one embodiment, the lower housing 110 has the plurality of stages 114C spaced apart from each other by a predetermined distance in the Y-axis direction. The upper housing 120 has the pair of legs 121 spaced apart from each other by the predetermined distance in the Y-axis direction, and each of the legs 121 has the corresponding pair of claws 121B. The coil holder 223 has the pair of mounting plates 224 spaced apart from each other by the predetermined distance in the Y-axis direction.

Thus, according to the vibration generating device 100 of one embodiment, the coil holder 223 can be positioned and fixed at two locations in the Y-axis direction. Therefore, it is ensured that play of the coil holder 223 can be limited in the up-down direction and the horizontal direction relative to the housing 101.

Moreover, in the vibration generating device 100 according to one embodiment, even when manufacturing variations occur in the positional accuracy of the pair of legs 121 of the upper housing 120 in the Y-axis direction, it is ensured that the pair of claws 121B provided on each of the pair of legs 121 can be inserted into the corresponding mounting plates 224 by elastically deforming a portion of the upper housing 120 between the pair of legs 121.

In the vibration generating device 100 according to one embodiment, the elastic support 250 is fixed to the bottom plate 110A of the lower housing 110.

Thus, according to the vibration generating device 100 of one embodiment, the bottom plate 110A of the lower housing 110, which serves as a height reference for the coil holder 223 in the up-down direction, can also serve as a height reference for the elastic support 250 in the up-down direction.

That is, the height reference for the coil holder 223 is the stage 114C that is provided integrally with the bottom plate 110A of the lower housing 110 and located at a predetermined height from the bottom plate 110A. Therefore, even when manufacturing variations occur in the width of the mounting plate 224, it is possible to easily improve the accuracy of the distance in the height direction between the yoke 210 and the magnets 231, 232, 233, 241, 242, and 243 retained by the elastic support 250, and the coils 221 and 222. Accordingly, it is possible to provide the highly accurate vibration generating device 100.

In the vibration generating device 100 according to one embodiment, the vibration unit 200 includes the plurality of coils 221 and 222 arranged in the Y-axis direction, and the plurality of magnets 231, 232, 233, 241, 242, and 243 arranged in the Y-axis direction.

Accordingly, in the vibration generating device 100 according to one embodiment, the distances in the up-down direction between the coils 221 and 222 and the magnets 231, 232, 233, 241, 242, and 243 can be maintained constant. Therefore, it is possible to provide the highly accurate vibration generating device 100.

In the vibration generating device 100 according to one embodiment, the sidewalls 111F and 111B of the lower housing 110 are each formed with the cutouts 112 that extend downward and into which the corresponding legs 121 of the upper housing 120, that are plates, are inserted from above. Each leg 121 is wider than the corresponding cutout 112 in the Y-axis direction at a portion having the pair of claws 121B. The claws 121B of the corresponding pair are provided inward of the sidewalls 111F and 111B of the lower housing 110 to overlap the sidewalls 111F and 111B within the internal space 101A of the housing 101.

Accordingly, in the vibration generating device 100 according to one embodiment, the sidewalls 111F and 111B of the lower housing 110 can restrict the legs 121 inserted into the corresponding cutouts 112 from opening outward beyond the cutouts 112 due to an impact or the like.

In the vibration generating device 100 according to one embodiment, each leg 121 includes the body 121A configured as a plate disposed within the corresponding cutout 112, and the pair of claws 121B protruding downward and laterally from the opposite lower ends of the body 121A in the Y-axis direction.

Accordingly, in the vibration generating device 100 according to one embodiment, the body 121A of each leg 121 can be disposed within the corresponding cutout 112 without protruding outward beyond the sidewalls 111F and 111B of the lower housing 110.

In the vibration generating device 100 according to one embodiment, the Y-axis direction is a direction of vibration generated by the vibration unit 200.

Accordingly, in the vibration generating device 100 according to one embodiment, play of the vibration unit 200 can be limited in the first direction relative to the housing 101 when the vibration unit 200 vibrates in the first direction.

In the vibration generating device 100 according to one embodiment, the coil holder 223 may be formed of a material softer than that of the upper housing 120.

Accordingly, in the vibration generating device 100 according to one embodiment, for example, opposite ends of the mounting plate 224 of the coil holder 223 can be wedged into engagement with the inner edges 121Ba of the claws 121B of the corresponding pair. Therefore, play of the coil holder 223 can be further reduced in the Y-axis direction relative to the housing 101.

In the vibration generating device 100 according to another embodiment, each leg 121 has the claw 500 protruding downward. Each mounting plate 224 is provided with the through-hole 510. The claw 500 fits into the through-hole 510. The claw 500 is tapered so as to gradually narrow downward.

Although one embodiment of the present invention has been described in detail above, the present invention is not limited to the embodiment. Various modifications and changes can be made within the scope of the gist of the present invention recited in the claims.

For example, in the above embodiment, the “coil” is retained by the “retainer” and the “magnets” are retained by the “elastic support.” However, the “magnets” may be retained by the “retainer” and the “coil” may be retained by the “elastic support.”

For example, in the above embodiment, the sidewalls 111L, 111R, 111F, and 111B and the cutouts 112 are provided on the lower housing 110. However, the sidewalls 111L, 111R, 111F, and 111B and the cutouts 112 may be provided on the upper housing 120, or may be provided on both the upper housing 120 and the lower housing 110.

For example, in the above embodiment, in each of the two retention structures provided in the left-right direction (Y-axis direction), the opposite ends of the mounting plate 224 are pressed by the claws 121B of the corresponding pair. However, the present invention is not limited to this configuration. For example, of the two retention structures provided in the left-right direction (Y-axis direction), one of the claws 121B of the pair may press one end of the mounting plate 224 in one retention structure, and the other of the claws 121B of another pair may press the other end of the mounting plate B in the other retention structure.

For example, in the above embodiment, the magnets are provided both above and below the coils (i.e., the coils are interposed between the magnets in the up-down direction). However, the present invention is not limited to this configuration. For example, the magnets may be provided only above the coils or only below the coils.

What is claimed is:

1. A vibration generating device, comprising:
a metal housing including a lower housing and an upper housing; and
a vibration unit provided inside the metal housing and having a magnet and a coil that are arranged to face each other in an up-down direction, the vibration unit configured to generate vibration in a first direction orthogonal to the up-down direction, wherein
the vibration unit includes:
an elastic support configured to support one of the coil or the magnet such that the one of the coil or the magnet can vibrate in the first direction; and
a retainer configured as a metal plate configured to retain the other of the coil or the magnet,
one of the upper housing or the lower housing includes a positioning portion provided at a predetermined height from a bottom plate of the one of the upper housing or the lower housing,
the other of the upper housing or the lower housing includes a leg configured as a plate,
the retainer includes a mounting plate protruding from an outer edge of the retainer and clamped between the positioning portion and the leg,
the leg includes a pair of claws spaced apart from each other in a horizontal direction orthogonal to the up-down direction and protruding in a distal direction of the leg,
the mounting plate fits between the claws, and
inner edges of the claws are inclined such that a distance between the claws gradually increases toward the distal direction of the leg.

2. The vibration generating device according to claim 1, wherein
the one of the lower housing or the upper housing includes a pair of positioning portions spaced apart from each other by a predetermined distance in the horizontal direction orthogonal to the up-down direction, each of the positioning portions being the positioning portion,
the other of the lower housing or the upper housing includes a pair of legs spaced apart from each other by the predetermined distance in the horizontal direction, each of the pair of legs being the leg including the pair of claws, and
the retainer includes a pair of mounting plates spaced apart from each other by the predetermined distance in the horizontal direction, each of the mounting plates being the mounting plate.

3. The vibration generating device according to claim 1, wherein
the elastic support is fixed to the bottom plate of the one of the lower housing or the upper housing.

4. The vibration generating device according to claim 3, wherein
the vibration unit includes:
coils arranged in the first direction, each of the coils being the coil; and
magnets arranged in the first direction, each of the magnets being the magnet.

5. The vibration generating device according to claim 1, wherein
the one of the lower housing or the upper housing includes a sidewall and a cutout formed in the sidewall, the cutout extending in the up-down direction and configured to receive the leg of the other of the lower housing or the upper housing,
the leg is wider than the cutout in the horizontal direction orthogonal to the up-down direction at a portion having the pair of claws, and
the pair of claws are located inward of the sidewall of the one of the lower housing or the upper housing so as to overlap the sidewall in an internal space of the one of the lower housing or the upper housing.

6. The vibration generating device according to claim 5, wherein
the leg includes:
a body configured as a plate disposed within the cutout; and
the pair of claws provided at distal opposite ends of the body in the first direction and protruding in the up-down direction and laterally.

7. The vibration generating device according to claim 1, wherein
the retainer is formed of a material softer than that of the other of the lower housing or the upper housing.

8. The vibration generating device according to claim 1, wherein
the horizontal direction is the first direction.

9. A vibration generating device, comprising:
a metal housing including a lower housing and an upper housing; and
a vibration unit provided inside the metal housing and having a magnet and a coil that are arranged to face each other in an up-down direction, the vibration unit configured to generate vibration in a first direction orthogonal to the up-down direction, wherein
the vibration unit includes:
an elastic support configured to support one of the coil or the magnet such that the one of the coil or the magnet can vibrate in the first direction; and
a retainer configured as a metal plate configured to retain the other of the coil or the magnet,
one of the upper housing or the lower housing includes a positioning portion provided at a predetermined height from a bottom plate of the one of the upper housing or the lower housing,
the other of the upper housing or the lower housing includes a leg configured as a plate,
the retainer includes a mounting plate protruding from an outer edge of the retainer and clamped between the positioning portion and the leg,
the leg includes a claw protruding in a distal direction of the leg, the mounting plate has a through-hole,
the claw fits into the through-hole, and
the claw is tapered so as to gradually narrow toward the distal direction of the leg.
